(19) United States
(12) Patent Application Publication
(10) Pub. No.: US 2016/0335629 A1
(43) Pub. Date: Nov. 17, 2016

(54) RIGHTS TRANSFER AND VERIFICATION

(71) Applicant: EUROCLEAR SA/NV, Brussels (BE)

(72) Inventor: Angus Scott, London (GB)

(73) Assignee: EUROCLEAR SA/NV, Brussels (BE)

(21) Appl. No.: 15/112,766

(22) PCT Filed: Jan. 20, 2015
(86) PCT No.: PCT/EP2015/051020

§ 371 Date: Jul. 20, 2016

(30) Foreign Application Priority Data
Jan. 20, 2014 (GB) 1400915.3

(51) Int. Cl. G06Q 20/38; G06Q 40/00; G06Q 40/06; G06F 21/62; G06Q 20/12

(52) U.S. Cl. CPC G06Q 20/3829; G06F 21/6209; G06Q 20/1235; G06Q 40/06; G06Q 40/10

(57) ABSTRACT

System and method for securely transferring rights comprising an ownership log of holding transfer certificates, wherein each holding transfer certificate contains data associated with an asset and is recorded against a public key of the owner of the holding. A transaction processor configured to transfer ownership of holdings, the transaction processor configured to receive a first block of data digitally signed by a first owner and having a first holding transfer certificate digitally signed by the first owner, the first block of data describing a first holding offered by the first owner in exchange for a requested second holding. Receive a second block of data digitally signed by a second owner and having a second holding transfer certificate digitally signed by the second owner, the second block of data describing a third holding offered by the second owner in exchange for a requested fourth holding. Authenticate the digital signature of the first holding transfer certificate and the first block of data with one or more public keys of the first owner. Authenticate the digital signature of the second holding transfer certificate and the second block of data with one or more public keys of the second owner. On successful authentication of the first and second holding transfer certificates and the first and second blocks of data, record in the ownership log the first holding against a public key of the second owner and record in the ownership log the third holding against a public key of the first owner.

### FIELD OF THE INVENTION

The present invention relates to a method and system for transferring rights and in particular for transferring rights with reduced risk.

### BACKGROUND OF THE INVENTION

“Rights” are commitments to a future benefit, made by one party to another. Financial securities are one class of right, but there are many others.

A right can be a contractual instrument that offers the holder a benefit at some point in the future. A holding may be a group of identical (or similar) rights in the possession of the same owner. Many types of financial instruments may be included, for example equities, bonds, deferred payments and derivatives. Rights may include non-financial instruments such as tickets to events or travel, pre-paid subscriptions or possession of goods in transit.

While different rights confer different benefits, business activity involving rights should address some or all of three basic problems:

1) Defining and fixing the rights so that they cannot subsequently be changed unilaterally or disputed;

2) Identifying that a holder of a given right is legitimate, particularly when they come to claim the benefits attached to it; and

3) Transferring rights from issuers to holders and subsequently between holders more efficiently and with a reduced risk for either party. Risks in a transaction can arise because:

a. One party can commit to a transaction in good faith but find that the counterparty is unable to complete. The first party has, in the meantime, foregone opportunities to enter into other transactions, and may be exposed to adverse price movements in the time between committing and discovering that the trade won't settle. This may be described as adverse selection risk.

b. Many transactions involve two or more legs; for example, a transfer of a good in exchange for a payment. If the one leg completes before the other, the party still awaiting completion faces credit risk: they have fulfilled their side of the bargain but, as yet, have nothing to show for it.

These issues are not new and there are well established techniques for dealing with them.

Rights are normally defined and fixed in legal contracts, issued in paper, often signed by both parties and sometimes witnessed by a third party such as a notary. These documents go by a number of different names depending on the context, including contracts; terms and conditions and prospectuses.

The other two issues, which are related, are may be dealt with in one of two ways:

1) Giving holders of the right another document, the presentation of which is required to claim the benefit.

These documents can be called vouchers, tickets, or certificates; and

2) Maintaining a register of the identities of the holders. A register can be maintained directly by the issuer of the right (or a registrar acting on their behalf). Alternatively, it can be maintained by a third party organisation, often called a custodian or a nominee. In this case, the custodian usually has a holding of the right in its own name and the register it maintains represents the beneficial interest of its clients in the holding. In some cases, there can be several layers of custodian between an end holder and the issuer of the right they hold. Registration is the favoured method in modern finance.

However, these established solutions are not well adapted to the digital age. Transactions and services may be limited if confined to these existing solutions. In the financial realm (as well as others) people are reinventing business models in many different areas including:
Cash flow management, through services such as Market Invoice;
Equity fund raising, through crowd funding platforms such as CrowdCube;
Corporate lending, through peer to peer lending platforms such as Funding Circle; and
Trading, where services such as Derivatrust enable counterparties to find each other and negotiate trades directly, without the need for a dealer or an exchange.

Beyond financial services, more and more transactions are being negotiated and agreed online for goods and services in both the digital and the physical world. In all of these cases, technology allows people to find counterparties and agree terms seamlessly and without friction. However, at this point, the sleek digital highway comes to an abrupt halt, and travellers must choose between some decidedly old-world alternatives to continue their journeys.

The first barrier is fixing the rights to be transferred in the first place. Paper contracts, double signed and notarised are hardly practical. Yet electronic documents are easy to amend by either the issuer or the holder, creating opportunities for dishonesty and dispute. To avoid this, contracts can be deposited with third parties, which add cost and delay.

Once this hurdle has been cleared, issuers of rights face a choice. To continue the highway metaphor, the choice is between using an unmade track or a railway.

The unmade road is like a certificate based approach. Low tech and traditional, certificates do have some advantages. They are cheap to create and hold and, where transactions are negotiated face-to-face, can be exchanged without adverse selection or credit risk. However, using them slows transaction speed to a walking pace and they cannot support high traffic volumes. Moreover, because certificates can be lost or destroyed and are easy to forge, it is easy for users to incur losses.

Attempts to bring paper certificates into the digital world face the problem that electronic documents are even easier to copy than physical ones. To counter this problem, issuers of electronic certificates have tended to restrict transferability of the right. This requires them to collect and store some form of identity for the right holder, such as a passport number or credit card details, or to use digital rights management software, which prevents copying of content. Such restrictions may be acceptable in some contexts; for example, on international flights where seats have to be allocated to a named individual. In other cases, they would seem to be an undesirable infringement of the property rights of a holder: why shouldn't someone be able to transfer a right that they own to someone else to enjoy in his place? Using them also increases the administrative burden on the issuer.

If the dirt track is too slow, bumpy and unreliable, the alternative is to take the train. Registration systems are the railways of transaction processing: more efficient and reliable for high volume transfers between fixed destinations to regular timetables, but requiring heavy, centrally operated infrastructure that is inflexible to handle any deviation from the norm, and, once built, slow and expensive to change.

The issues with registration systems include:

1. Maintaining data on the identities of parties named on the register. That means keeping up to date with a succession of corporate re-organisations and name changes, not to mention house moves and probates of private individuals. The custodian/nominee model outlined above mitigates these costs for the central registrar, but the price for this is heavy intermediation. This increases costs, creates credit risk and adds time lags to processes, since it takes time to communicate between holders, counterparties and intermediaries. This is one reason why, for example, trades in equities typically settle two to three days after they are agreed.

2. Ensuring that holdings recorded on the register are up to date with the results of transactions agreed between holders. The difficulties include:

a. Verifying the identity of parties instructing updates to the register to prevent fraud;

b. Ensuring that both sides to a transaction agree its terms, often achieved through a process of matching corresponding “deliver” and “receive” instructions; and

c. Managing time delays between agreeing a transaction and updating the register, exacerbated where instructions have to be passed through several layers of intermediaries. Such delays magnify adverse selection risks and are problematic when it comes to distributing benefits to holders. People often buy a right in anticipation of receiving a benefit, but delays in updating the register cause the benefit to be paid to the previous holder. The new holder therefore has to claim the benefit from the old holder, which is expensive and inefficient and creates credit risk.

3. Managing changes initiated by the issuer that affect the values recorded on the register. These changes can include anything from name changes, to changes in the number of rights in issue, to complex events such as takeovers. Often, they have an optional element, requiring communication between the issuer and the holder before the register is updated. The way in which different types of events are handled in law, regulation or market practice differs by instrument type and jurisdiction, complicating the task of maintaining a register still further. Finally, in an intermediated model, changes at the centre need to be replicated in the sub-register maintained by each layer of custodian.

4. Managing credit risk. Many changes to a register arise from transactions where a right is transferred from one party to another in exchange for cash. To avoid credit risk arising from this process, the system that updates the register must be tightly coupled with the banking system via a central bank or another credit institution so that the cash payment occurs simultaneously with the register update. This adds further complexity to the design of the infrastructure and also means that the register must operate to the same working day as the rest of the banking system.

5. It is difficult for the holder of a particular right to prove their holding to a third party without giving up a lot of data about their identity and possibly providing powers of attorney to their counterparties, which is cumbersome. Conversely, proof of ownership received from a registered keeper is obsolete the moment it is issued, particularly in a high transaction environment. This has a significant consequence. Trading venues such as stock exchanges depend on the fact that bargains struck using their systems are subsequently honoured by both sides. Since it is hard to prove ownership of cash or securities directly, they usually restrict participation to parties considered to have the credit quality to stand behind their trades. In turn, this has means that:

a. End holders need credit lines with brokers, which requires costly capital to be set aside; and

b. Anonymity between exchange participants is problematic. Anonymity is desirable to prevent leakage of price data. However, it conflicts with the need for firms to manage the adverse selection risk they incur with their counterparties in the time between trading and settlement. Central counterparties are one way to resolve this conflict, but their use adds additional infrastructure and requires further capital.

6. It can be difficult for the issuer to know the identities of the holders of its securities since the use of custodians and nominees means that beneficial owners often do not appear on the register.

7. Once established, it can become very difficult to change registration based models. In particular, the need for tight coupling between registration, transaction processing, event processing and cash systems in the centre and at multiple intermediaries makes co-ordinating change complex and expensive, especially where the costs and benefits are borne by different parties. In this environment, major change can only occur when pushed through by public authorities or regulators.

In order to maintain high levels of security, current systems include highly complex and cumbersome computer systems that require high levels of computing power, large storage facilities and very high bandwidth communications networks (to reduce latency). Such solutions are therefore, far from ideal, expensive to build and operate (in terms of computing resources) and inflexible to modify when requirements (both technical and non-technical) change.

Therefore, there is required a method and system that overcomes these problems.

### SUMMARY OF THE INVENTION

Against this background and in accordance with a first aspect there is provided a system for securely transferring rights comprising: an ownership log of holding transfer certificates, wherein each holding transfer certificate contains data associated with an asset and is recorded against a public key of the owner of the holding; and a transaction processor configured to transfer ownership of holdings, the transaction processor configured to: receive a first block of data digitally signed by a first owner and having a first holding transfer certificate digitally signed by the first owner, the first block of data describing a first holding offered by the first owner in exchange for a requested second holding; receive a second block of data digitally signed by a second owner and having a second holding transfer certificate digitally signed by the second owner, the second block of data describing a third holding offered by the second owner in exchange for a requested fourth holding; authenticate the digital signature of the first holding transfer certificate and the first block of data with one or more public keys of the first owner; authenticate the digital signature of the second holding transfer certificate and the second block of data with one or more public keys of the second owner; and on successful authentication of the first and second holding transfer certificates and the first and second blocks of data, record in the ownership log the first holding or holding transfer certificate against a public key of the second owner and record in the ownership log the third holding or holding transfer certificate against a public key of the first owner. Therefore, it is possible to determine the legitimate owner of an asset or holding before it is transferred to a new owner. Any potential acquirer of a right or any other party can determine the legitimacy of the right for transfer and so this improves security. This may be achieved by authenticating the holding transfer certificate (perhaps within a proposed or offered block of data) against the offeror's public key. Preferably, they may also authenticate all previous owners or holders (against their own public keys) as each transfer may be recorded or “nested” within the holding transfer certificate. Anonymous but safe transactions are possible as ownership can be determined from digital signature verification that doesn't require knowledge of identity. Ownership can be more traceable, and again verifiable using the current and preferably all previous public keys applied to the holding transfer certificates. The offered holdings may be described as transaction inputs and the requested holdings may be described as transaction output. Preferably, the inputs should therefore match the outputs for each transaction, regardless of the number of data blocks that form each transaction. Rather than concentrating data around complex, tightly coupled, centralised processes, it reduces the degree of centralisation, enabling users to develop highly flexible, distributed business models, that can be optimised to suit many different needs, whilst retaining high levels of security and reducing computing requirements.

When a party (e.g. the first or second owner) signs an object or item of data (e.g. a holding transfer certificate or a block of data) then that involves applying to the item of data a function based on a private key preferably known only to that party. The signed item of data is therefore verifiable (as being signed by the party) using a corresponding public key. As the party is the only entity with access to the private key then only they can digitally sign the item of data.

The public key should have an associated private key to be used in authentication. Each owner or holder may have more than one public/private key pairs, generate them as required or receive them from a key issuing authority as and when required. Each owner may rely on a single public/private key pair with which to sign data blocks and holding transfer certificates or these items may be signed by different public keys belonging to the same owner (to improve security and anonymity).

The ownership log may contain details of holdings in rights, recorded against a public key of the owner of the holding. The holding transfer certificate may be contained within the block of data received and digitally signed, and contains the data related to the holding to be offered, including data that records its provenance as a valid holding, linked to the first holding created by the issuer (which may be called the “Prime holding”, to distinguish from the first holding offered by the first owner). The digital signature of the current holder may act as proof of intention to transfer.

The holding transfer certificates (or any of the certificates mentioned) may also be described as certificates or simply as data items containing verifiable or authenticatable facts.

Optionally, recording in the ownership log the first holding transfer certificate against the public key of the second owner and recording in the ownership log the third holding transfer certificate against the public key of the first owner may be prevented from occurring unless the first holding matches the fourth holding and the second holding matches the third holding. In other words, the holding offered by the first owner matches the holding requested by the second owner and the holding offered by the second owner matches the holding requested by the first owner. This can be a requirement in the special case that there are two parties to a single transaction (see FIG. 10 described in more detail below). However, in general there may be more than two parties to a transaction and each party may have their own request that should be satisfied.

Preferably, the transaction processor may be further configured to record in the ownership log the first holding transfer certificate against a public key of the second owner and record in the ownership log the second holding transfer certificate against a public key of the first owner simultaneously. In other words, both holding transfer certificates may be recorded at the same time, so that there is reduced counterparty risk. Each owner is therefore guaranteed to either keep their initial holding (but not receive a new holding) or to receive a new holding (and lose their initial holding). Each owner can be assured that they will not lose both holdings, whilst the counterparty gains both holdings.

Preferably, the holding transfer certificates may be digitally signed by an issuer as the initial owner of a holding. This is how new holdings are created.

Preferably, the first and second holding transfer certificates may be digitally signed by all previous owners and the transaction processor is further configured to authenticate the digital signatures of all previous owners applied to the first and second holding transfer certificates before proceeding to record in the ownership log the first holding transfer certificate against the public key of the second owner and record in the ownership log the second holding transfer certificate against the public key of the first owner.

Optionally, the ownership log may further record the public keys of all previous owners of each holding and data indicating which of the public keys identifies the latest owner of the holding. Therefore, the full ownership history of a holding may be verified.

Optionally, the system may further comprise a transaction log recording a transaction identifier against all transactions of each holding. This can be used to link transactions to holdings to provide an archive of transactions (that may be queried and confirmed) all of the way back to an issuer.

Preferably, the ownership log may further include the transaction identifiers of transactions relating to each holding certificate.

Optionally, the system may further comprise a holdings log configured to store the holding transfer certificates. This may provide a less complex way to verify a holding's history.

Preferably, each owner has one or more public keys corresponding to one or more private keys usable to digitally sign holding transfer certificates and data blocks. Whilst the system may function with each owner having a single public/private key pair, they may have multiple key pairs to sign with. This can improve anonymity. Furthermore, a new key pair may be generated for each holding or for each transaction. Additionally, the public key used to sign the holding transfer certificate used to offer a holding by an owner may be the same as or different from the public key used to record the holding received by the same holder in the transaction in question.

Optionally, the first block of data may further describe one or more conditions to be confirmed by the transaction processor before recording in the ownership log the first holding certificate against the public key of the second owner. Similarly, the second (or further) blocks of data may also contain conditions. Conditions allow transactions to be restricted to certain classes of owners or so that transfers only occur when other requirements are met. Additionally, conditions may be recorded or stored in various forms or at various locations. For example, the conditions may be stored against details of rights themselves as well as being specific to particular transactions involving those rights.

Optionally, one or more conditions may be selected from the group consisting of: eligibility requirement of the second owner; registration status of the second owner; age of the second owner; citizenship of the second owner; time limits; tax to paid; can the holding be divided; reference to a third data block that must be processed at the same time; and minimum or maximum holding size. Additional conditions may be applied. Conditions may be specified for all transactions involving particular rights or on a transaction by transaction basis, for example. These conditions may generally be enforced by a transaction processor or other mechanism, for example.

Optionally, the data associated with the asset may be a reference to a right certificate. The data associated with the asset may be data describing the asset itself or in this case a reference or identifier to a further data object (right certificate) that contains details of the asset.

Preferably, the right certificate may be digitally signed by an issuer of the asset. This provides additional security and system integrity.

Optionally, the right certificate may contain data indicating legal and/or business details of the asset.

Advantageously, the data may be a link, pointer, URL or URI to text describing the legal and/or business details of the asset. This allows greater detail to be specified without increasing the data volume either for (storage or transmission) within the system and so affords greater computing efficiency.

Preferably, the system may further comprise a transaction assembler configured to assemble two or more blocks of data into a single transaction. The transaction assembler may therefore form part of an exchange or matching and settling system. The transaction assembler allows different owners (counterparties) to engage in a transaction without them having to identify each other in advance. Provided that each owner receives the holding that they require and any conditions are met then transactions may be assembled and executed successfully. The transaction assembler (or several) may operate outside of the system. It is not necessary for the transaction assembler to be used as part of the validation of transactions. However, it may be used to perform some level of pre-checking before transactions are submitted for validation.

The sum of offered holdings should ideally equal the sum of requested holdings. In some embodiments, surplus holdings may be re-assigned to the original key (i.e. owner). Therefore, a requirement may be to ensure that the sum of the offered holdings is greater than or equal to the sum of the requested holdings over all the blocks in the single transaction, with any excess of offered holding over requested holding being recorded against the original public key of the offeror of the excess holding.

Advantageously, the transaction assembler may be further configured to ensure that a sum of the offered holdings match a sum of the requested holdings over all of the blocks in the single transaction.

Preferably, the public key of the first owner recorded in the ownership log against the first holding transfer certificate is the same public key of the first owner used to authenticate the first holding transfer certificate and/or the first block of data, and/or

the public key of the second owner recorded in the ownership log against the second holding transfer certificate is the same public key of the second owner used to authenticate the second holding transfer certificate and/or the second block of data.

According to a second aspect, there is provided a method for securely transferring rights using holding transfer certificates containing data associated with assets, the method comprising the steps of: receiving a first block of data digitally signed by a first owner and having a first holding transfer certificate digitally signed by the first owner, the first block of data describing a first holding offered by a first owner in exchange for a requested second holding; receiving a second block of data digitally signed by a second owner and having a second holding transfer certificate digitally signed by the second owner, the second block of data describing a third holding offered by the second owner in exchange for a requested fourth holding; authenticating the digital signature of the first holding transfer certificate and the first block of data with one or more public keys of the first owner; authenticating the digital signature of the second holding transfer certificate and the second block of data with one or more public keys of the second owner; and on successful authentication of the first and second holding transfer certificates and the first and second blocks of data, recording in the ownership log a holding transfer certificate matching the requested second holding against a public key of the first owner and recording in the ownership log a holding transfer certificate matching the requested fourth holding against a public key of the second owner.

Preferably, the second holding transfer certificate is the holding transfer certificate that matches the requested second holding and the first holding transfer certificate is the holding transfer certificate that matches the requested fourth holding.

Optionally, the method may further comprise the steps of:

retrieving from an ownership log a public key of the first owner associated with the first holding transfer certificate; and

retrieving from the ownership log a public key of the second owner associated with the second holding transfer certificate,

before authenticating the digital signatures of the first and second holding transfer certificates and the first and second blocks of data. Therefore, the ownership log maintains a current or latest (perhaps time stamped) entry of holding transfer certificates associated with or stored against public key of the latest owner to be used when authenticating their digital signatures. The first and second owners may have one or more public keys (associated with different holding transfer certificates) stored in the ownership log. In other words, each owner may change their public keys at intervals or even for each individual holding transfer certificate.

Preferably, the method may further comprise the step of recording in a holdings log the first and second holdings transfer certificates.

Optionally, recording the first holding transfer certificate against a public key of the second owner and recording the second holding transfer certificate against a public key of the first owner may be a single transaction, and the method may further comprise the step of recording the single transaction in a transaction log. More than two holding transfer certificates (and data blocks) may form a single transaction (for example, see FIG. 11 described in further detail below).

Optionally, the method may further comprise the steps of:

receiving a third block of data digitally signed by a third owner and having a third holding transfer certificate digitally signed by the third owner, the third block of data describing a fifth holding offered by the third owner in exchange for a requested sixth holding;

authenticating the digital signature of the third holding transfer certificate and the third block of data with one or more public keys of the third owner; and

on successful authentication of the third holding transfer certificate and the third block of data, recording in the ownership log the first holding transfer certificate against a public key of the second owner and recording in the ownership log a holding transfer certificate matching the requested sixth holding against a public key of the third owner. Fourth, fifth and further owners, data blocks and holding transfer certificates may be added in similar ways.

Optionally, the first holding transfer certificate may be the holding transfer certificate that matches the requested sixth holding and the fifth holding transfer certificate is the holding transfer certificate that matches the requested fourth holding. Therefore, each owner received their requested holding.

Optionally, the assets may be selected from the group consisting of: cash, equities, derivatives, options, forward contracts, tickets, bookings, products, and services. Other assets (tangible and intangible) types may be used.

The methods described above may be implemented as a computer program comprising program instructions to operate a computer. The computer program may be stored on a computer-readable medium.

The computer system may include a processor such as a central processing unit (CPU). The processor may execute logic in the form of a software program. The computer system may include a memory including volatile and non-volatile storage medium. A computer-readable medium may be included to store the logic or program instructions. The different parts of the system may be connected using a network (e.g. wireless networks and wired networks). The computer system may include one or more interfaces. The computer system may contain a suitable operation system such as UNIX, Windows (RTM) or Linux, for example. Databases may run a suitable database system such as Oracle (RTM), for example.

It should be noted that any feature described above may be used with any particular aspect or embodiment of the invention.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system for transferring rights, given by way of example only;

FIG. 2 shows a flowchart of a method executed by the system of FIG. 1;

FIG. 3 shows a schematic diagram of data describing a right;

FIG. 4 shows a schematic diagram of data describing an initial holding transfer;

FIG. 5 shows a schematic diagram of data describing an existing holding transfer;

FIG. 6 shows a schematic diagram of a block of data including the holding transfers of FIGS. 4 and 5;

FIG. 7 shows a schematic diagram of data including the blocks of data of FIG. 6;

FIG. 8 shows a table of holdings against public keys of the owner of those holdings;

FIG. 9 shows a table of transactions of the holdings of FIG. 8;

FIG. 10 shows a schematic diagram of a transfer of rights between two owners;

FIG. 11 shows a schematic diagram of a transfer of holdings between three owners; and

FIG. 12 shows a schematic diagram of a further embodiment of a system for transferring rights.

It should be noted that the figures are illustrated for simplicity and are not necessarily drawn to scale. Like features are provided with the same reference numerals.

### DETAILED DESCRIPTION OF THE PREFERRED EMBODIMENTS

In one example implementation, useful additional features of the method and system include:

1) Rights are identified by using an identifier derived cryptographically from the contents of a “prospectus” document that defines the right. This approach means that the identifier may become a seal on the prospectus: any change to the prospectus would result in a different identifier;

2) Issuers of rights can set conditions on future transfers that are then enforced by the method and system through a transaction management process. Issuers can use conditions to influence the transactions themselves; for example by imposing a time limit on transferability of the instrument or requiring that a transaction includes a payment to a third party such as a tax authority. Alternatively or additionally, issuers or subsequent owners or holders can define eligibility conditions for future holders, such as that holders must have a certain regulatory status, or the identity of holders (new owners) has been verified and will be made available to the issuer or current owner on request. These conditions may be enforced using a distributed verification model, as outlined in point 6 below.

3) Individual holdings may be recorded as rights using cryptographic identifiers. As a result, no data on the identity of the holders needs to be maintained. However, the identifiers enable holders to prove their status so that they can establish their credentials as owners, instruct transfers and collect benefits.

4) Transactions in rights may be built of individual blocks, each of which specifies an input (a holding that is committed to a transaction) and an output (the “consideration” requested or asked for in return, expressed in terms of a quantity of another right (or criteria for acceptable quantities of certain rights)). Multiple blocks from many different counterparties can be assembled to create a transaction and blocks can be used as tools to find counterparties and negotiate prices prior to assembling transactions (see below for examples). When a transaction is received, the system validates it to ensure that each holding input is valid (preferably using the cryptographic identifiers), that the overall transaction balances (inputs (offered) equal outputs (requested)) and that any conditions are met before updating all registers of holdings simultaneously. This process ensures that, no matter how complex the transaction, a reduced or preferably no credit risk is created between counterparties.

5) The system may be open to anyone to use and may be available around the clock. Transactions received are preferably evaluated and processed immediately, subject to strict prioritisation based on time of receipt or other criteria.

6) While it is not necessary for the system to maintain data about holders, it supports a powerful eligibility model, driven by the conditions set by the issuers when creating individual rights or subsequently applied. Where these conditions exist, prospective holders must approach a trusted third party that can verify that they meet the conditions and then provide a cryptographic certificate for inclusion in a transaction block. The system may use these certificates as proof of eligibility when evaluating a transaction. For example, suppose that an issuer imposed a condition that a right could only be held by firms regulated as wholesale market participants by the Financial Conduct Authority (FCA). The FCA could issue certificates to the firms it regulates, and the system may check for these certificates in transaction blocks where the right in question was specified as an output or requested holding.

The system may add additional services such as a library of the rights of each instrument registered; numbering and classification services or confirmation services (trade status for participants that wish to include a communication address on their transaction blocks), and/or private key management services.

The service enables improved flexibility, in a large number of business and other contexts. The implications include:

Rights

1. The system may support any type of right, issued by any type of organisation, in compliance with any legal framework. The ease of creation for rights make it applicable for issues which would be far too small to operate in current registration systems;

2. Among the supported instruments are “cash”, or electronic bankers' drafts, i.e. claims on cash deposits at issuing banks. These enable transactions to settle for cash without the need to integrate the system into a banking infrastructure; and

3. The ease with which rights can be created enables many composite securities to be unbundled into their constituent parts. For example, bonds may be broken down into their individual coupons and redemption payments, each of which may be held separately. This simplifies processing (see below) and also creates many more trading and financing opportunities

Holding, security and identity

1. It is not necessary for the system to collect any data on holders, meaning it is easy for them to access the service directly, reducing the need for intermediaries. Owners hold their private keys (part of the cryptographic identifiers of holdings) in software applications on their own systems. These applications may contain many value added features such as classification systems, valuation tools, tools to manage transactions, redemptions and distributions. In effect, they are electronic custodians;

2. Holdings are secure. Transfer of a holding is only possible with the private key of the holder, which should never leave his possession. A transaction log may be protected against fraudulent change because of the integrity of the chains of signed transactions going back to the first issuance of the right;

3. The nature of the transaction protocol makes it easier to upgrade encryption standards as they evolve. Holders could simply use transactions to re-assign their holdings to themselves under encryption keys to the new standard, at a time of their choosing;

4. Holders may easily manage their holdings in individual rights using the standard transaction protocol. This allows them to consolidate or split holdings for ease of administration or to support different trading strategies;

5. It is easy for holders to reveal a holding to a third party, by signing a statement to the third party with the private key that represents the holding. The third party may verify this signature against the public key maintained by the system. Because the system records only holdings, this process preferably reveals no other information about the holder;

6. The use of eligibility criteria within the terms of the right enables improved flexibility, allowing issuers to set eligibility criteria appropriate to the terms of the right being issued, without requiring the maintenance of a complex central data model. Some rights may need no criteria and these may be held completely anonymously. In other cases, an issuer can obtain the identities of some or all parties holding its right. This may leverage the natural synergies that exist because certain organisations already collect data to evaluate eligibility in the course of other business activities.

Transactions, distributions and redemptions:

1. The block structure of the transaction protocol makes it extremely flexible. Each block contains a very limited set of data, while the input/output structure guarantees delivery vs. payment and reduces or eliminates credit risk. Because all blocks have to be signed by the current holder of the rights being committed, it is possible to verify that a potential counterparty is genuine before agreeing to a trade, limiting adverse selection risk. When the condition is enforced that all blocks in a transaction must settle or none settle, there is no credit risk exposure in the transaction.

2. The ability to assemble multiple blocks in a single transaction enables the use of intermediaries such as exchanges or brokers to bring together counterparties who do not know of each other, again without the end parties being exposed to credit risk with the intermediaries.

3. It is possible for a holder to use a block as an offer, published to many potential counterparties, any of whom could use it in a transaction. However, the system may only process the first block it receives via a valid transaction; all others would be rejected.

4. Applications supported by the transaction protocol may include:

a. Exchange based trading. In this application, the transaction blocks are used to create limit orders for use on an exchange. Each holder signs its inputs (offered holding) to the exchange which then displays the blocks on its order book and onward sign holdings to a counterparty to complete a trade. Since the exchange is able to verify the signatures of each counterparty against the public holdings register, its service is open to anyone with holding.

b. Price negotiation. Two potential counterparties may use blocks to negotiate the terms of the transaction. Counterparty A assigns his input to party B in a block and specifies his output “price” (requested holding or output). If Party B thinks the price is too high he can create another block and specify via his inputs a lower price. Party A can then modify his block to accept the revised terms and send the transaction in for verification.

c. Block trading, where a number of funds may issue transaction blocks, assigning rights to a broker, who can use the same transaction to execute with a market-side counterparty, thereby enabling the funds to use the broker's trading skill without taking any credit risk on him.

d. Tax payments. If a transaction is liable for tax (e.g. UK SDRT), payment of the tax may be specified as a condition of transfer in the issue. The liable party then creates an additional block in the transaction assigning the required amount to a public key published by the tax authority. The tax rate may be defined in the conditions attached to the right being transferred.

e. Dividends and income. In this application, holders create transaction blocks assigning their holdings to the issuer and specifying the required value of “cash” instruments as outputs. For coupons this may be all that was required. Dividends holders may also specify an appropriate quantity of new “ex-div” instruments. The holder sends this block to the issuer, who creates a matching block and sends the transaction for completion. Note that there is no need for ex-date and record date deadlines in this process. Once the issuer has announced that the benefit is available, holders can claim it in their own time and ex and cum versions of an instrument can exist in parallel. There are therefore no claims.

f. Complex corporate actions. More complex corporate actions are dealt with in a similar way to dividends, except that i) benefits are instruments other than “cash and ii) the holders use the output section of the block to specify their choices when there are options.

g. Benefits outside the system. In some cases, benefits may not be delivered via a transaction. For example, holders of a “cash instrument” may want to transfer their holding to an account in the banking system. In this case, the holder creates the block transferring the holding to the bank and sends it to the bank, along with details of the account to pay to. The bank creates an “acknowledgement security”- an individual right that encapsulates the details of the external transaction (e.g. account details, amount and value date for the credit to the holders' bank account). It then assigns this to the holder in another block and sends the transaction to the system to arrange the transfer.

Fees:

It is very easy for any service provider supporting this type of transactions, including the system itself, to collect fees from clients by requiring that clients include blocks transferring the appropriate fees to the service provide within the transactions.

As an open service, people can find many different and unexpected ways in which it is useful. This section highlights some business applications to illustrate the sorts of uses to which it can be put.

Financial:

The system can significantly lower the costs of issuing, holding and transacting in financial instruments. These costs include computing resource requirements. One area that this is particularly useful is in capital raising, where rights may be used to support various types of instruments including:
Cash, where banks can issue rights to cash deposits, as described above. Cash rights act as electronic money, and would therefore have a multitude of uses.
Bonds, where each coupon and redemption payment is modelled as a separate right, which simplifies the transactions needed to claim these payments and also opens interesting asset liability opportunities for holders. For example, an issuer can create a swap without needing a bank intermediary by issuing a set of rights that match expected income receipts and using the proceeds to buy a set of cash flows that pay out when expected payables become due.
Equities. The system supports traditional equities. In addition, the low cost of creation and distribution of securities makes them suitable for use in contexts where registration models are too costly; for example to support capital raised by Crowdfunding platforms.
Voting: it is relatively easy to strip out the voting rights contained within equities and distribute them separately from the participation rights. The system works in conjunction with electronic voting services to enable right holders to easily and more securely identify themselves before voting.
Working capital- rights are useful in invoice factoring markets. Debtors may issue promissory notes as rights to creditors, who can then sell them to third party investors, who can also trade them among themselves.

Other financial market applications may include:
Depository receipts: existing instruments may be held at a depository and Rights issued on the back of the holding. This enables a much more flexible and low cost custody offering, compared with those that currently exist.
Derivatives: rights can be a convenient way to model cash flows or other obligations arising from certain derivative contracts. An advantage is that they can be distributed without dealer intervention and, once issued, are easy to transfer. Examples include:
   Forwards, where delivery price is fixed;
   Swaps, where each cash point are created as a separate security; and
   Margin calls—counterparties to a derivative transaction can use Ostrich instruments to pre-structure variation margin. Each would write the other a series of rights to claim cash, contingent on certain conditions. These rights can be transferred to third parties (perhaps with conditions), increasing flexibility.

Other:

Non-financial applications of the system include:
Tickets, enabling real time issuance of tickets, up to the limit of their validity. Subject to the preference of the issuer, the system also facilitates a secondary market using internet services such as eBay or twitter, for example. Such a system may be popular with ticket holders. It also improves the cash flow of issuers, allowing them to pre-sell blocks of tickets to on-line re-sellers, without risk of fraud.
Digital content—Access to digital content. Content publishers provide owners with a right, registered on the system. The publishers may then require that owners register with them periodically, using the right, to continue to access the content. While the key could be copied, the publisher can only enable one computer to register with them per period. Registration may be a background process, transparent to users. Users can sell the content and transfer the right to a new owner. The publisher can specify, as a condition of the right that enables registration, that such transfers are accompanied by a royalty payment in their favour. As for tickets, such an approach can help publishers as well as users by allowing them to distribute their content through third parties, without needing to trust the third parties to be honest.
Physical goods—The system can facilitate credit risk free escrow services between parties agreeing to transact in goods over the internet, for example. The seller may advertise the good and, on agreement of a sale, can create a transit right that describes the good and certified transfer of ownership. They can assign this right to a third party such as a delivery company, in exchange for the agreed payment. The buyer may then assign the payment to the delivery company, and specify the transit right as output. The delivery company then delivers the good and, if the buyer is happy, add an additional block to the transaction to transfer the payment to the seller and the transit right to the buyer. If not, they can return the good to the seller. At no point is the delivery company able to claim the buyer's cash, so neither party has any credit exposure to them.

This approach operates in a highly flexible, open way that enables it to be incorporated into many different business applications, with significant potential to reduce costs, risks and capital and to improve security.

The system provides an environment where the holders of rights can assert their holding with absolute certainty in a way that can be verified by other participants, enabling transactions to be performed with a high degree of certainty but preserving the anonymity of participants (and their holdings) where necessary. This generic process can be applied into many different business contexts, enabling increased efficiency, flexibility and innovation.

Terms and abbreviations

Right: The definition of an instrument (financial or otherwise) that can be traded through the service.

Holding: The quantity of a particular right held by an individual (or organisation).

Transaction: An (preferably, atomic) operation where holdings from one or more participants are redistributed according to the wishes of, and agreement between, those participants.

Consideration: The new holding received by a participant in a transaction in return for the holding given away.

Eligibility: The rules or qualifications required to be met to possess a certain holding.

Certificate: A cryptographically signed digital document.

Block: One input to a transaction. A transaction will be made up from one or more blocks.

The following outlines some advantages of the service:

Transparency: A participant is able to verify directly the legitimacy of right for transfer.

Anonymity: It is possible to transact anonymously. It is also be possible to protect the privacy of aggregated rights ownership (“position”).

Traceability: The service (but not the participants) are able to trace ownership when required for regulatory, law enforcement and other purposes.

Longevity: The service allows ownership to be asserted over very long periods of time (and in some cases infrequently).

Flexibility: The service can support many instrument, asset and right types.

Immediacy: Any potential acquirer of right is able to determine instantaneously (real time) the legitimacy of the right for transfer. Furthermore, the transfer itself can be immediate and atomic, leaving no scope for ambiguity.

Conditionality: The system supports the participants to specify strict conditions to their transfers (e.g. “I will transfer this holding to you, if and only if, you transfer that holding to me”).

Finality: Every transaction (consisting of a number of transfers) either:
Completes (or “settles”) in its entirety (all transfers successful); or
Fails in its entirety (no transfers successful)

Advantageously, it can made impossible for a transaction to partially complete.

Every completed transaction may therefore be final and indisputable.

Non-duplicating: “double spending” can be prevented, i.e. transfer a right to one party, then transfer same right to another.

Divisibility: It can be possible to divide and combine quantities of rights in a flexible generic manner (if permitted by the terms of the right).

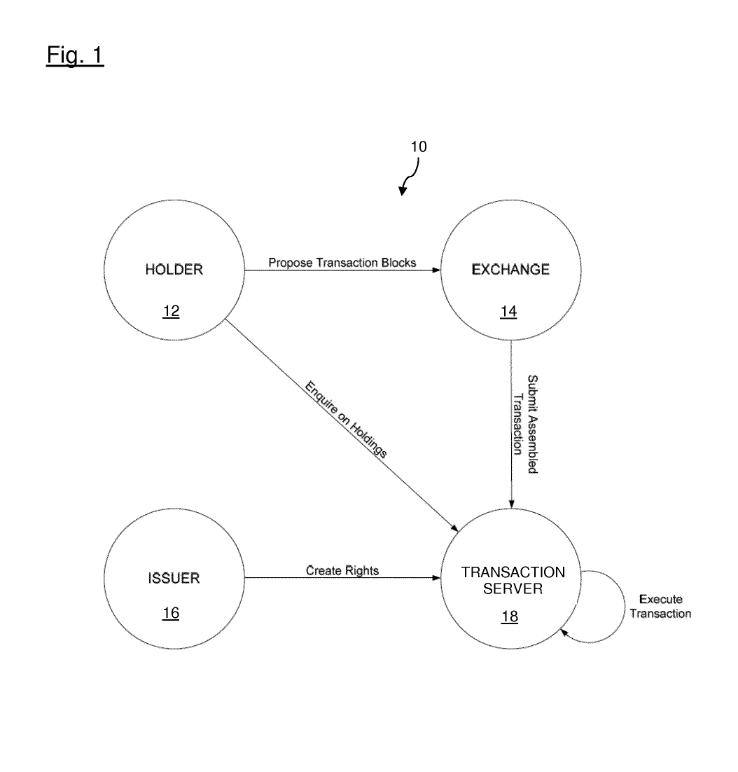

FIG. 1 illustrates at a high level the concept of the system. This is summarised as follows:
Issuers of rights 16, will register those rights in the system 10 and become the initial holder of them.
Holders of rights 12 can then exchange the various rights issued into the system. This is achieved by creating “Transaction Blocks” which are offers to exchange a holding for a consideration (i.e. someone else's holding within the system 10 or a value outside of the system 10).
An exchange or transaction assembler 14 can orchestrate transactions by putting together “transaction blocks” that provide a complete balanced transaction (i.e. all the inputs (offered holdings) to the transaction equal all the outputs (requested holdings)).
A transaction server 18 provides a mechanism for executing the assembled transaction, as well as being the authoritative source on holdings at any point in time.

The service provides participants (i.e. current and future holders) with the tools to determine that other participants are indeed the holder of particular rights. It is possible to do this with varying levels of privacy determined by the participants and/or issuers.

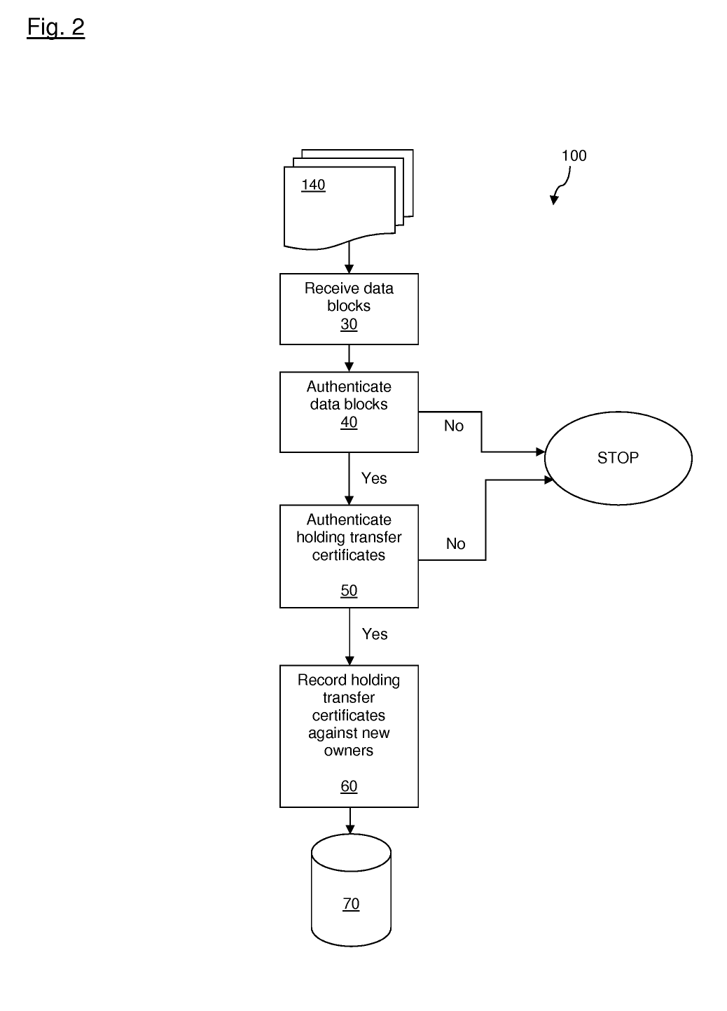

FIG. 2 illustrates schematically a method 100 carried out by the system 10 to process transactions. The transaction assembler receives data blocks 140 formed from holding transfer certificates 120, 130 (either newly issued or previously transferred) at step 30. The transaction assembler 14 may provide the transaction server 18 with authenticated data blocks at step 40 and may authenticate holding transfer certificates contained within the data blocks at step 50. Whilst the transaction assembler 14 may pre-validate transactions, it is the transaction server 18 that carries out the required or final validation of transactions. If either of these authentication steps fail, then the process stops and the transaction will fail. Upon successful authentication of both data blocks and holding transfer certificates, then the holding transfer certificates are recorded against new owners at step 60, which are stored in database 70.

FIG. 3 illustrates the most basic construct in the service, that of a “right” in the form of a right certificate 110. A “right” is any instrument that can be represented by a contract. Examples include:
financial instruments such as bonds, securities and derivatives; and
non-financial instruments such as theatre tickets and software licenses.

The system 10 is constructed as a generic service for any instrument type.

The details of the instrument are contained within the “Prospectus”, which contains all of the necessary business and legal details of the instrument concerned.

The signature of the issuer across the right prevents the prospectus being altered to prevent both the issuer and future holder from disputing the wording. It may not be necessary for the entire Prospectus text to be included in the right certificate 110. For example, a Uniform Resource Identifier URI, may show where the details of the instrument can be obtained, together with a cryptographic hash of the document, may provide a cost effective way to provide a robust definition of the right.

A conditions section in the right certificate 110 may contain general conditions, that could apply to any instrument and which are used by the system 10 to ensure that only legitimate transactions are performed. Example conditions include:
Eligibility: Are there eligibility requirements or not? Can this instrument be exchanged with anyone or not?
Limit of Transfers: Are there any limits on the number of times the holding can be transferred?
Time Limit: Is there a time limit on when the holding can be transferred?
Divisibility: Can a fractional quantity of the right be held or does the right always need to be held as numbers of whole units?
Tax: Is there a requirement to include transaction tax payments or exemptions in any transfer?

The issuer may appoint one or more trusted third parties or other service providers to ascertain eligibility as opposed to, or in addition to the specific conditions in the right certificate 110. In this case, the rights certificate may specify the proof to be provided by the trusted third party that a potential holder of the right has met the eligibility criteria. For example, to be eligible to obtain a theatre ticket it may be necessary to determine that the potential holder is over a certain age. This criterion may not be relevant to many financial instruments which instead may need to apply other criteria.

A unique right ref is an identifier that distinguishes this right uniquely from all other rights in the system 10. A mechanism for generating these identifiers may be provided by the system 10.

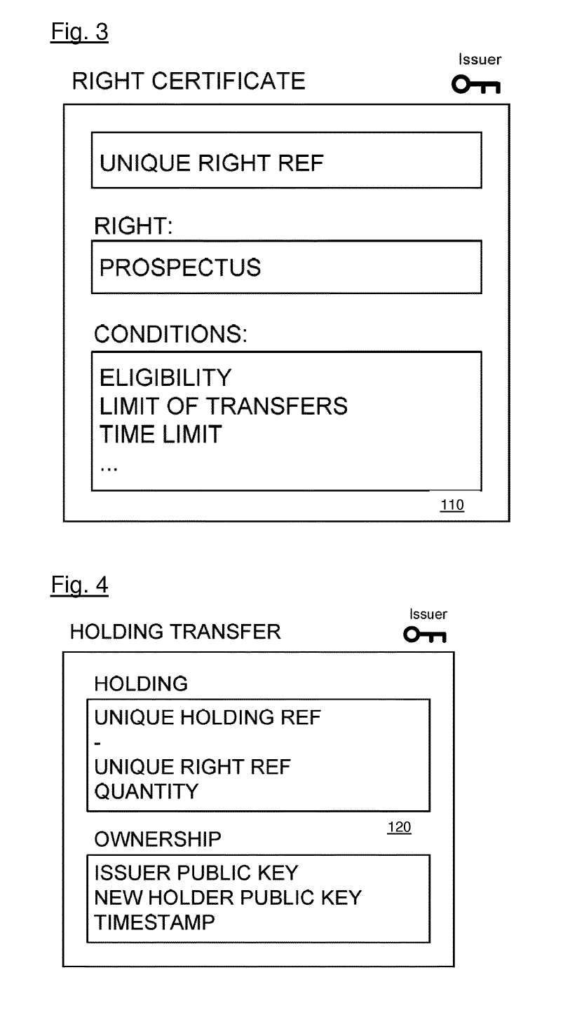

For each right the issuer 16 may issue a certain quantity (holding) of that “right”. Initially it is envisaged that the issuer 16 will own all holdings of the right. Holdings are assigned to new participants through the holding transfer certificate 120, 130, which transfers the holding from the old holder to the new holder. FIG. 4 illustrates that first transfer from the issuer to the first holder. This is a special case of the generic holding transfer certificate 130 described in more detail below. The transaction server 18 verifies the identity of an issuer 16 to prevent fraud. This may be done using standard PKI complemented by appropriate identity assurance processes.

FIG. 5 illustrates the generic transfer of a holding from one participant to another. Components of the generic holding transfer certificates 130 may include:

Holding:

Unique Holding Ref: An identifier that distinguishes this holding from all other holdings in the system 10. Note that when the holding is transferred, divided in multiple holding or combined with other holdings, that each new holding will have a new unique reference. Previous Holding Ref: The previous unique holding ref.

This provides a chain of holdings all the way back to the issuer 16.

Unique Right Ref: The unique reference for the right in question.

Quantity: The quantity of the right held.

Ownership:

Old Holder Public Key: The public key of the old holder (owner). The old holder will have in their possession the corresponding secret private key (for authentication).

New Holder Public Key: The public key of the new holder (owner). The new holder will have in their possession the corresponding secret private key.

Timestamp: The timestamp may be applied, by the old holder, at the time the holding certificate is generated.

For a holding transfer certificate 130 to be a valid input to a transaction it must be signed by the private key corresponding to the public key held in the ownership log 160(see below). The holding transfer certificate 130 then binds the holding to the new holder's public key.

Currently it is assumed that holdings will be fungible. If an item is not fungible (e.g. a theatre ticket for a specific seat is not the same as a theatre ticket for a different seat) then it is assumed that a separate right would be needed (e.g. one right per theatre ticket).

To prevent a holding transfer certificate 130 from being transferred twice (double spending) the ownership log 160 (described below) provides the authoritative statement on who owns what at any point in time. In addition to transferring a holding to a specific individual (where their public key is known) it may also be possible to use an intermediary to transfer holdings to unknown parties.

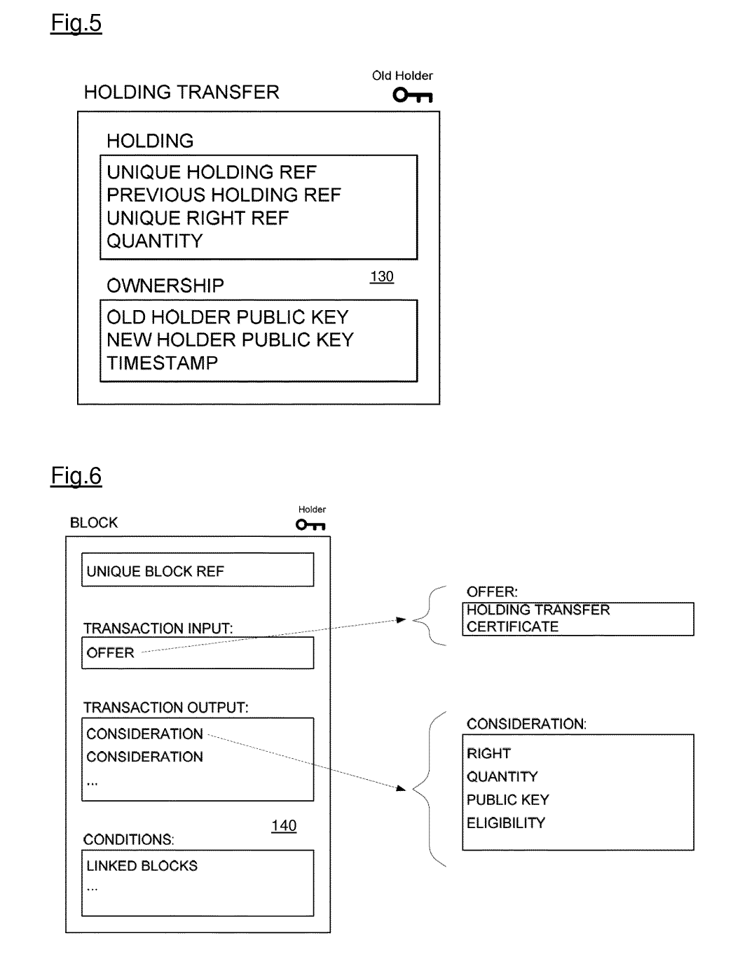

A transaction may be made up from a number of transaction blocks or blocks of data 140 (two or more). Each block may include the following (as illustrated in FIG. 6):
Transaction Input: The holding that the participant is offering as part of the transaction. Note that because the transaction block 140 is signed with the holder's key, only one holding can be placed as an input into a transaction block. If a participant wishes to offer multiple holdings into a transaction each holding may require its own block.
Transaction Output: What the participants wants to receive from the transaction. This will define a number of considerations consisting of:

The right that is requested;

The quantity of that right that is requested;

The public key to which that right will be transferred. The holder or new owner will be in possession of the corresponding secret private key; and

Evidence of eligibility for the right, if the right has eligibility requirements placed on it. The transaction output could also contain criteria that define or constrain the considerations, without precisely specifying them (e.g. at least 10 of type a, b, or c).
Conditions: Restrictions placed on the transactions including:

Linked blocks, which lists the unique block ref for all blocks that must be included with this block in any transaction. This will allow the holder to offer multiple holdings into a transaction as indicated above. Conditions and considerations may be defined using a flexible scripting language. The above structure does not include the concept of price (of either the unit of input or output). Price is implicit in the fact that the participant is offering an amount of one right in return for specified amounts of other rights. However, a price may be incorporated more explicitly in certain embodiments.

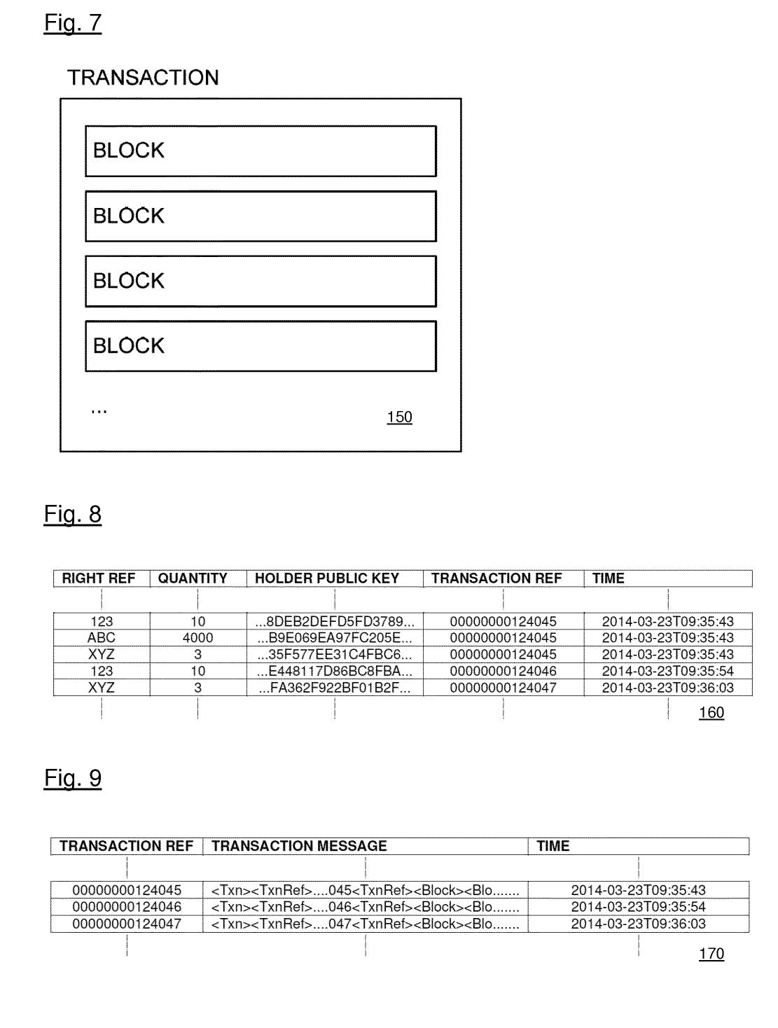

As illustrated in FIG. 7, a transaction 150 may consist of a number of blocks. For the transaction 150 to be complete the total transaction inputs (contained within the blocks) must equal the total transaction outputs, i.e. the transaction should not add or delete any value from the system but simply redistribute holdings according to the agreement of the transaction participants. The transaction 150 may be put together by the exchange or transaction assembler 14 especially where the participants do not know each other. The transaction assembler 14 may be incorporated within or external to the transaction server 18.

Alternatively and especially where the participants do know each other, one of them can take responsibility for compiling the complete transaction.

The transaction 150 is sent as a single message into the transaction server 18, which, as an atomic operation:
Confirms that all transaction inputs (holdings) are still owned by the claimed holder (i.e. still associated with the correct public key in the ownership log - see below);
Confirms that the total transaction inputs match the transaction outputs;
Confirms that all conditions are met (if present);
Confirms that all eligibility requirements are met;
Verifies or authenticate all digital signatures (on holding transfer certificate 130 and transaction blocks 140)
Updates the ownership log (see below) to reflect the new holdings; and
Stores the transaction message in the transaction log (see below).

FIG. 8 illustrates the ownership log 160 in further detail. This may be the authoritative record on who owns which holdings at any point in time. Holdings (i.e. a quantity of a certain right) will be associated with the holder's public key. No other information is required to identify the holder. The holder can demonstrate ownership through signing a holding transfer certificate 120, 130 with the corresponding private key. The record in the ownership log 160 has an associated transaction reference which will link it to the transaction log 170.

FIG. 9 illustrates the transaction log 170 in further detail. This may provide an archive of all transactions that can be queried to confirm the proper transfer of holdings (within the context of transactions) preferably all the way back to the issuer 16. In addition to the transaction log 170, a holdings log may be maintained, which stores the holdings transfer certificates 120, 130 only. This may provide a less complex way to verify a holding's history. The transaction log 160 is however sufficient to determine the history as the transaction messages contain the holding transfer certificates 120, 130. Note that the transaction log 170 can preserve the anonymity of holders and the privacy of holdings information (if necessary), as the participants are free to choose separate key pairs for each new holding they acquire should they wish.

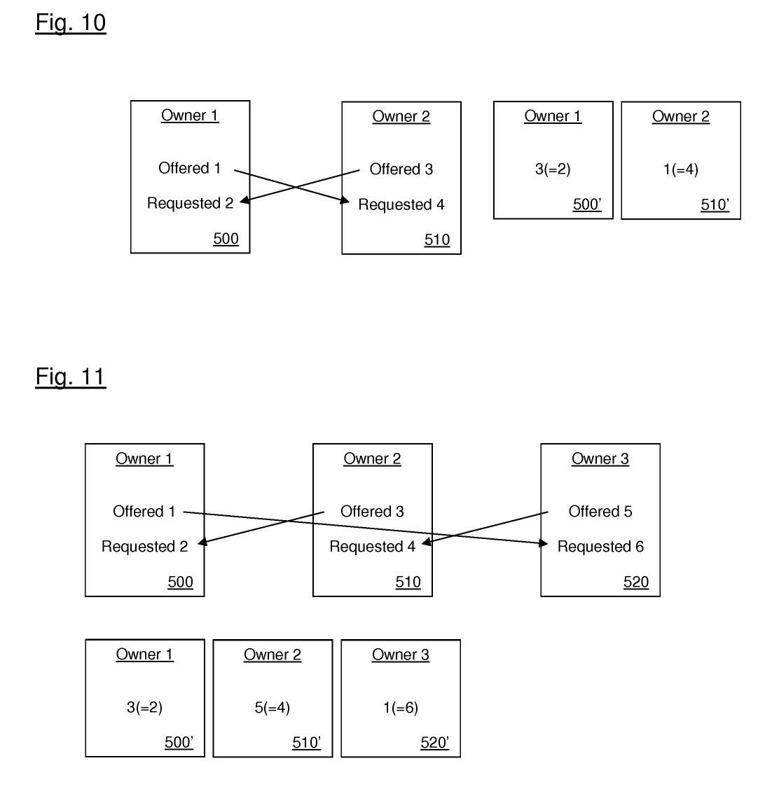

FIG. 10 illustrates schematically a simple transaction involving two holders or owners. A portion of the holding transfer certificate is illustrated for both owners 500, 510.

Owner or holder 1 offers holding 1 and requests holding 2. Owner 2 offers holding 3 and requests holding 4. Providing that the system 10 determines that requested holding 2 matches offered holding 3 and requested holding 4 matches offered holding 1, then the transaction is successful and the holdings will be transferred as shown in boxes 500 and boxes 510.

FIG. 11 illustrates schematically a further example transaction but this time including three owners or holders of rights. It is not possible to satisfy any two of the three owners by matching only two blocks of data as all three are now required to balance the transaction (all inputs equal all outputs). Owner 1 again offers a first holding and requests a second holding. Owner 2 again offers a third holding and requests a fourth holding. Owner 3 (as shown in the portion of data block 520) offers a fifth holding and requests a sixth holding. Resultant holdings 500′, 510′ and 520′ indicate that owner 1 receives holding 3 from owner 2. Owner 2 receives holding 5 from owner 3. Owner 3 receives holding 1 from owner 1. As holding 3 is equal to holding 2, holding 5 is equal to holding 4, and holding 1 is equal to holding 6 then all owners are satisfied in their particular requested requirements.

Transactions 150 may be built up from 4, 5, 6 or indeed further data blocks.

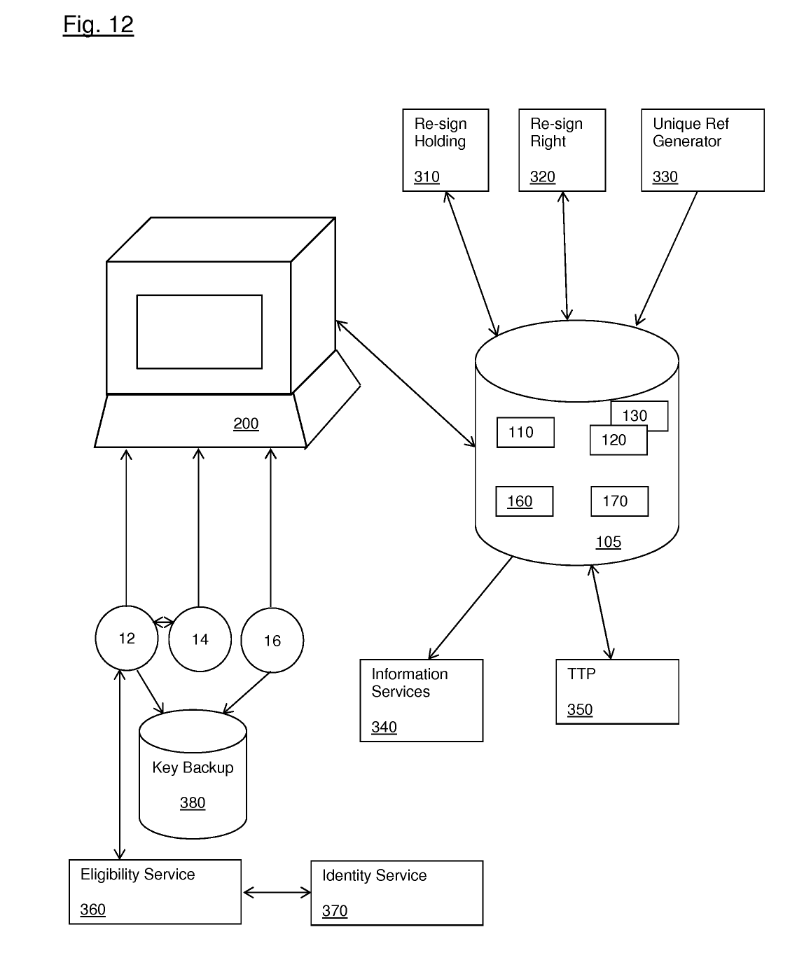

FIG. 12 shows the system 10 in further detail. In particular, FIG. 12 shows a processor 200 configured to implement the method described with reference to FIG. 2. The processor 200 is connected to a database 105 (or other suitable storage mechanism). Under certain embodiments, additional services may be provided. These additional services are illustrated in FIG. 12.

Some instrument types may have a very long life. In keeping with best practice for cryptographic key management, facilities are provided that allows issuers 16 and participants to increase cryptographic key lengths or to select an alternative cryptographic algorithm for their holdings. Certificates (or other documents) may be re-signed with longer keys before the current key lengths are deemed to have become weak (due to advances in cryptanalysis). The following services are provided:
Re-sign Holding 310: Allowing the holder 12 to associate a new key with their holding.
Re-sign Right 320: The issuer can re-sign the right certificate 110 with the new (longer) key. The unique right ref can stay the same in order that the affected holdings do not need to be changed. A process may be provided to ensure that the issuer 16 cannot change any aspect of the right (e.g. the wording of the prospectus) during such an operation.

Unique Ref Generation 330:

The service uses globally unique references to ensure each item in the system is identifiable and distinct. These references may be generated by a third party or by the system 10 itself. Unique numbers will need to be generated for:
Unique Right Ref;
Unique Holding Ref; and
Unique Block Ref.

It may be possible to generate these references using hashing techniques (e.g. hash the prospectus to obtain the Unique Right Ref) to reduce the number of centralised services that the system 10 needs to provide.

Information Services 340

The following types of information may be made available to participants:
The current ownership of rights, to give them greater confidence that transactions will be successful;
The transaction log, so that they can examine the history for themselves; and
The status of transactions including whether completed transactions succeeded or failed.

The system 10 may specify minimum standards for key lengths and algorithms.

Private Key Backup Services 350

Keys associated with holdings may be generated by the participants (i.e. outside of the system 10) meaning that the trust placed in the system 10 can be significantly reduced. It will be of great importance to all participants to protect their keys from both loss and compromise.

Third party key management products and services already exist that will be suitable for larger organisations. Small organisations or individual participants may however need assistance in providing adequate levels of protection for their keys. The system 10 can specify minimum standards, certification and auditing requirements for such services to protect participants.

Reduce Transaction Chains

Over time the chain of transactions from initial issuance of the right to the current holding may become very long. This can make the process of validating the entire chain (back to the issuer 16) increasingly time consuming and increase computing requirements of the system (e.g. processing, storage and network bandwidth).

Transaction chains may be reduced as follows:
A TTP (Trusted Third Party) 350 verifies the transaction chain from the start and up to some point (e.g.

in time or number of transactions). The TTP then publishes the established trusted point in the chain and participants then only need to check back as far as that point in the chain. Entries prior to the trust point may be archived, so that participants who still wanted to check the entire history could do so but with a reduced service level.
The issuer 16 (or a TTP working on their behalf), may verify the transaction chain from the start and up to some point in time. The issuer 16 may then create a new initial holding transfer certificate 120 for the first holder in the reduced chain. Depending on the level of verification performed during a transaction (e.g. if validating the entire chain), there may be a need for the transaction server 18 to be able to shorten transactions chains. This could be a service performed by one or more TTPs, or by the issuer 16 as described above.

Eligibility Service 360

There may be a variety of eligibility constraints on the transfer of a right or holding. These could include, for example:
Must be a known legal entity
Must be in a specific jurisdiction
Must meet compliance rules (e.g. AML, not disqualified as a director)
Is transaction wholesale or retail?
Does person meet age criteria (e.g. for buying a theatre ticket).

Ideally the system 10 will not restrict the types of eligibility requirement that can be placed on a right.

Instead, third party eligibility services may be established. When completing the consideration section of a block of data 140, the participant (holder 12 or issuer 16) sends the details of the right being requested to an approved eligibility service that can check the restrictions in the right and if appropriate issue an eligibility certificate to the participant for inclusion in the transaction block. The eligibility certificate would need to include the public key included by the participant in their transaction block 140.

This approach has the following benefits:
The participant can claim eligibility without needing to reveal anything else about their identity to the system 10, the other participants or the issuer. The eligibility service 360 may need to determine more about the participant's identity in order to support the claim.
The approach is scalable. New eligibility services 360 (or service capabilities) can be introduced as new classes of right are introduced into the system 10. Some eligibility certificates may need relatively short expiry periods to allow for changes in status. An alternative approach would be to define a set of eligibility conditions and allow participants to obtain eligibility certificates for one or more of those conditions. The transaction server 18 may then need to check the required conditions are met during the course of executing a transaction.

Identity Services 370

Linked to the eligibility service 360 it may be necessary to build some identity services, which may deliberately anonymous at the core.
Identity of Participants: Depending on the requirements of particular rights the following levels of identity are envisaged:

Participants who are anonymous

Participants who meet a known criterion (this may include the ability for law enforcement to determine the legal identity of the participant.

Participants who are known legal entities.

The necessary level of identity may be asserted through the eligibility certificate or by adding additional identity information into the consideration section of the transaction block 140.
Identity of Issuers: It is likely that participants will need to be able to determine the identity of issuers 16. The system 10 may need to verify the identity of issuers 16 to prevent fraud. This can be achieved through standard PKI and a simply directory, potentially complemented with relevant identity assurance services.

Use Cases

This section outlines example use cases or user journeys that may be supported by the system 10. The list is non-exhaustive.

Create and Register Rights

Complex right: Defining a right that includes a large prospectus, signing it (to “lock in” the contents) and registering it with the service.

Simple right: Defining a simple right, signing it and registering it with the service.

Rights with conditions: Define right that includes conditions on eligibility or transfer, signing it and registering it with the service.

Parties known to each other: Two or more participants, who are known to each other, construct transaction blocks 140. One of the participants takes responsibility for building the overall transaction message 150 and submitting it to the transaction server 18.

Parties not known to each other: Two or more participants, who are not known to each other, construct transaction blocks 140. Blocks are transferred to a TTP (an intermediary within the exchange 14 or the exchange itself) who then in the same transaction will transfer them to the intended recipient. The system 10 may need to recognise this transient (instantaneous) ownership of the exchange 14. The exchange or transaction assembler 14 will build the overall transaction and submit it the transaction server 18.

New holder with no previous rights: The new holder will provide a transaction block 140 that has no transaction inputs but the required transaction outputs. To ensure that the holdings are only transferred to the intended recipient the old holder must specify the correct public key of the new holder.

Such an exchange could be linked to the transfer of other rights or assets outside of the system 10.

Using linked blocks: The linked blocks feature can be used to split or recombine a holding. Use cases include:
Splitting
Consolidating
“Cashback”, where part of a holding is offered in a transaction but the remainder is to be held by the current holder.

Corporate Actions

Payment on presentation of coupon (as an example of a right): This will be a transaction with a transaction block as follows:
Input: the coupon being presented
Output: payment in the form of currency and a further transaction block from the issuer containing the outputs specified by the holder (cash, ex-div securities etc.)

Note in this case the holding will be deleted from the system.

Dividend payment (flowing from a right): This will be a transaction with a transaction block as follows:
Input: Current holding
Output: Payment and a new holding ex dividend

and a further transaction block from the issuer containing the outputs specified by the holder (cash, ex-div securities etc.)

Redemption (e.g. of theatre ticket): This will be a transaction with a transaction block 140 as follows:
Input: Holding
Output: Receipt

and a further transaction block from the issuer containing the outputs specified by the holder (cash, ex-div securities etc.)

Note in this case the holding will be deleted from the system 10.

As will be appreciated by the skilled person, details of the above embodiment may be varied without departing from the scope of the present invention, as defined by the appended claims.

For example, the assembly of blocks of data to create a transaction may be carried out by third parties external to the system. In some embodiments the blocks of data do not need to be signed by one, more or all of the owners or authenticated.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A system for securely transferring rights comprising:
an ownership log of holding transfer certificates, wherein each holding transfer certificate contains data associated with an asset and is recorded against a public key of the owner of the holding; and
a transaction processor configured to transfer ownership of holdings, the transaction processor configured to:
receive a first block of data digitally signed by a first owner and having a first holding transfer certificate digitally signed by the first owner, the first block of data describing a first holding offered by the first owner in exchange for a requested second holding;
receive a second block of data digitally signed by a second owner and having a second holding transfer certificate digitally signed by the second owner, the second block of data describing a third holding offered by the second owner in exchange for a requested fourth holding;
authenticate the digital signature of the first holding transfer certificate and the first block of data with one or more public keys of the first owner;
authenticate the digital signature of the second holding transfer certificate and the second block of data with one or more public keys of the second owner; and
on successful authentication of the first and second holding transfer certificates and the first and second blocks of data, record in the ownership log the first holding against a public key of the second owner and record in the ownership log the third holding against a public key of the first owner.

2. The system of claim 1, wherein recording in the ownership log the first holding transfer certificate against the public key of the second owner and recording in the ownership log the third holding transfer certificate against the public key of the first owner is prevented from occurring unless the first holding matches the fourth holding and the second holding matches the third holding.

3. The system of claim 1 or claim 2, wherein the transaction processor is further configured to record in the ownership log the first holding transfer certificate against a public key of the second owner and record in the ownership log the second holding transfer certificate against a public key of the first owner simultaneously.

4. The system according to any previous claim, wherein the holding transfer certificates are digitally signed by an issuer as the initial owner of a holding.

5. The system according to any previous claim, wherein the first and second holding transfer certificates are digitally signed by all previous owners and the transaction processor is further configured to authenticate the digital signatures of all previous owners applied to the first and second holding transfer certificates before proceeding to record in the ownership log the first holding transfer certificate against the public key of the second owner and record in the ownership log the second holding transfer certificate against the public key of the first owner.

6. The system according to any previous claim, wherein the ownership log further records the public keys of all previous owners of each holding and data indicating which of the public keys identifies the latest owner of the holding.

7. The system according to any previous claim further comprising a transaction log recording a transaction identifier against all transactions of each holding.

8. The system of claim 7, wherein the ownership log further includes the transaction identifiers of transactions relating to each holding certificate.

9. The system according to any previous claim further comprising a holdings log configured to store the holding transfer certificates.

10. The system according to any previous claim, wherein each owner has one or more public keys corresponding to one or more private keys usable to digitally sign holding transfer certificates and data blocks.

11. The system according to any previous claim, wherein the first block of data further describes one or more conditions to be confirmed by the transaction processor before recording in the ownership log the first holding certificate against the public key of the second owner.

12. The system of claim 11, wherein the one or more conditions are selected from the group consisting of:
eligibility requirement of the second owner; registration status of the second owner; age of the second owner;
citizenship of the second owner; time limits; tax to paid; can the holding be divided; reference to a third data block that must be processed at the same time; and minimum or maximum holding size.

13. The system according to any previous claim, wherein the data describing the asset is a reference to a right certificate.

14. The system of claim 13, wherein the right certificate is digitally signed by an issuer of the asset.

15. The system of claim 13 or claim 14, wherein the right certificate contains data indicating legal and/or business details of the asset.

16. The system of claim 15, wherein the data is a link, pointer, URL or URI to text describing the legal and/or business details of the asset.

17. The system according to any previous claim further comprising a transaction assembler configured to assemble two or more blocks of data into a single transaction.

18. The system of claim 17, wherein the transaction assembler is further configured to ensure that a sum of the offered holdings match a sum of the requested holdings over all of the blocks in the single transaction.

19. The system according to any previous claims, wherein the public key of the first owner recorded in the ownership log against the first holding transfer certificate is the same public key of the first owner used to authenticate the first holding transfer certificate and/or the first block of data, and/or
the public key of the second owner recorded in the ownership log against the second holding transfer certificate is the same public key of the second owner used to authenticate the second holding transfer certificate and/or the second block of data.

20. A method for securely transferring rights using holding transfer certificates containing data associated with assets, the method comprising the steps of:
receiving a first block of data digitally signed by a first owner and having a first holding transfer certificate digitally signed by the first owner, the first block of data describing a first holding offered by a first owner in exchange for a requested second holding;
receiving a second block of data digitally signed by a second owner and having a second holding transfer certificate digitally signed by the second owner, the second block of data describing a third holding offered by the second owner in exchange for a requested fourth holding;
authenticating the digital signature of the first holding transfer certificate and the first block of data with one or more public keys of the first owner;
authenticating the digital signature of the second holding transfer certificate and the second block of data with one or more public keys of the second owner; and
on successful authentication of the first and second holding transfer certificates and the first and second blocks of data, recording in the ownership log a holding transfer certificate matching the requested second holding against a public key of the first owner and recording in the ownership log a holding transfer certificate matching the requested fourth holding against a public key of the second owner.

21. The method of claim 20, wherein the second holding transfer certificate is the holding transfer certificate that matches the requested second holding and the first holding transfer certificate is the holding transfer certificate that matches the requested fourth holding.

22. The method of claim 20 or claim 21 further comprising the steps of:
retrieving from an ownership log a public key of the first owner associated with the first holding transfer certificate; and
retrieving from the ownership log a public key of the second owner associated with the second holding transfer certificate
before authenticating the digital signatures of the first and second holding transfer certificates and the first and second blocks of data.

23. The method according to any of claims 20 to 22 further comprising the step of recording in a holdings log the first and second holdings transfer certificates.

24. The method according to claims any of claims 20 to 23, wherein recording the first holding transfer certificate against a public key of the second owner and recording the second holding transfer certificate against a public key of the first owner is a single transaction, the method further comprising the step of recording the single transaction in a transaction log.

25. The method according to any of claims 20, 22 to 24, further comprising the steps of:
receiving a third block of data digitally signed by a third owner and having a third holding transfer certificate digitally signed by the third owner, the third block of data describing a fifth holding offered by the third owner in exchange for a requested sixth holding;
authenticating the digital signature of the third holding transfer certificate and the third block of data with one or more public keys of the third owner; and
on successful authentication of the third holding transfer certificate and the third block of data, recording in the ownership log the first holding transfer certificate against a public key of the second owner and recording in the ownership log a holding transfer certificate matching the requested sixth holding against a public key of the third owner.

26. The method of claim 25, wherein the first holding transfer certificate is the holding transfer certificate that matches the requested sixth holding and the fifth holding transfer certificate is the holding transfer certificate that matches the requested fourth holding.

27. The method according to any of claims 20 to 26, wherein the assets are selected from the group consisting of: cash, equities, derivatives, options, forward contracts, tickets, bookings, products, and services.

28. A computer program comprising program instructions that, when executed on a computer cause the computer to perform the method of any of claims 20 to 27.

29. A computer-readable medium carrying a computer program according to claim 30.

30. A computer programmed to perform the method of any of claims 1 to 27.
